(19) United States
(12) Patent Application Publication
(10) Pub. No.: US 2010/0133492 A1
(43) Pub. Date: Jun. 3, 2010

(54) Fencing system

(75) Inventor: Duane Langenwalter, Monroe, CT (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Garden Zone, LLC

(21) Appl. No.: 12/656,304

(22) Filed: Jan. 25, 2010

Related U.S. Application Data
(63) Continuation-in-part of application No. 10/797,410, filed on Mar. 10, 2004, now Pat. No. 7,677,534.

(51) Int. Cl. E04H 17/10; E04H 17/08; B23P 11/00

(52) U.S. Cl. 256/47; 256/32; 29/426.1

(57) ABSTRACT

A fencing system. Components may be joined in various combinations to create a limitless number of different configurations or arrangements. Stakes, posts, and chains may be attached to one another in multiple combinations. The posts are removably interchangeably inserted onto stakes set in the ground, thereby allowing each post to be rotated to any desired position. The stakes are first driven into the ground and the posts are then inserted into or onto a post-holder in the stake to provide support and stability for the fencing system. Chains are removably suspended between two selected posts. The chain may have post attachment collars with through bores, which are aligned, and the posts inserted therethrough into the post holding structure. Clamps attached below a lowermost post attachment collar suspend the chains to the posts.

This application is a continuation-in-part of Ser. No. 10/797,410, filed on Mar. 10, 2004, which is currently pending, the contents of which are incorporated herein by reference.

### BACKGROUND OF THE INVENTION

1. Field of the Invention

The present invention relates generally to a customizable decorative fencing system, and, more particularly, to a decorative fencing system that includes multiple components and may be arranged in a potentially infinite number of combinations and permutations so as to be used as a decorative accent fence for a carriage house, yard or walk, or a combination thereof.

2. Description of the Related Art

The related art fails to specifically address either the problem or the solution arrived upon by the applicant. Fencing systems are known in the industry, as is the use of sectional fence structures to create various configurations for fencing systems.

None of these related attempts offer the solution proposed by the applicant.

### SUMMARY OF THE INVENTION

The present invention provides a customizable fencing system, having several components that may be arranged in a substantially limitless number of configurations or combinations.

The present invention may also provide a fencing system that may be used as a small or low fence, or a decorative accent for a carriage house, yard or walk, or a combination thereof.

The present invention may also provide a decorative fencing system that allows a user to purchase and use only those elements necessary to create the design or shape of his or her choosing.

The present invention may also provide a fencing system that is easy to assemble, disassemble, customize and revise, and reassemble.

The present invention may also provide a fencing system that may be either permanently or temporarily affixed to the ground.

The present invention may also provide a fencing system which includes all the elements necessary to create a fence.

The present invention provides a fencing system which may include a variety of interchangeable decorative elements.

The present invention provides a decorative fencing system in which the individual components may be manufactured from a variety of materials or can be provided with a variety of finishes.

The present invention comprises a customizable fencing system designed to be used as a small fence or decorative accent for a carriage house, yard, or walk, or a combination thereof. The fencing system includes several different components that may be joined in various combinations so as to create a limitless number of different configurations or arrangements. Post sections can include open d-rings clamped thereon, with one distal end of a chain suspended on an open d-ring of one selected post, and another distal end of the chain suspended on an open d-ring of an adjacent post. Alternatively, the chains can be provided with post attachment collars at each respective distal end, each post attachment collar having a bore provided therethrough with a diameter larger than the diameter of each post, so that the ends of the posts can be inserted through the bores of the post attachment collars. Removable clamp rings can be attached to the posts below the post attachment collars to hold the post attachment collars in position. When a pair of adjacent chain ends are to be attached to one post, the bores of the two respective post attachment collars bores are aligned, and the post inserted therethrough. The post sections are removably, interchangeably secured to the ground by means of stakes that are driven into the ground. In one embodiment, the post is slidably, removably, interchangeably inserted into a sleeve in the stake to thereby provide support and stability for the fencing system. Each stake sleeve has a diameter larger than the diameter of each post, so the posts removably, interchangeably insert into each stake sleeve and are removably, frictionally held in place therein. Alternatively, in another embodiment, the stake includes a projecting portion, which can removably, interchangeably insert into a sleeve provided in a lower distal end of each post. A diameter of the sleeve in each post is larger than a diameter of each stake projecting portion. The projecting portions removably, interchangeably insert into sleeves of selected posts, and are removably, frictionally held in place therein. The posts can be placed at different distances apart, varying the taughtness of the suspended chains, and also can be placed so as to define a variety of angles between any two adjacent posts. The posts and stakes can be inserted together, assembled, e.g., in one desired pattern, then disassembled and reassembled in another desired pattern, without moving the stakes. Alternatively, if desired, during disassembly, one or more of the stakes can be withdrawn from the ground and moved to different locations prior to reassembling the fence in another desired pattern.

### BRIEF DESCRIPTION OF THE DRAWINGS

The advantages of the present invention will be more apparent from the detailed explanation of the preferred embodiments of the invention in connection with the accompanying drawings, wherein:

FIG. 1 is a front elevational view of one embodiment of a base unit of a fencing system according to one embodiment of the present invention.

FIG. 2 is a front elevational view of another embodiment of a base unit of a fencing system according to another embodiment of the present invention.

FIG. 3 is an exploded front elevational view of one embodiment of a post and stake of the fencing system of the present invention.

FIGS. 4A and 4B are exploded front elevational views of another embodiment of a post and stake of the fencing system of the present invention.

FIG. 5 is an exploded part view of one embodiment of a chain that is suspended between posts, used in the embodiment of FIG. 1.

FIG. 6 is an exploded part view of another embodiment of a chain that is suspended between posts, used in the embodiment of FIG. 2.

FIG. 7 depicts perspective views illustrating various configurations of the fence system of the present invention.

### DETAILED DESCRIPTION OF THE INVENTION

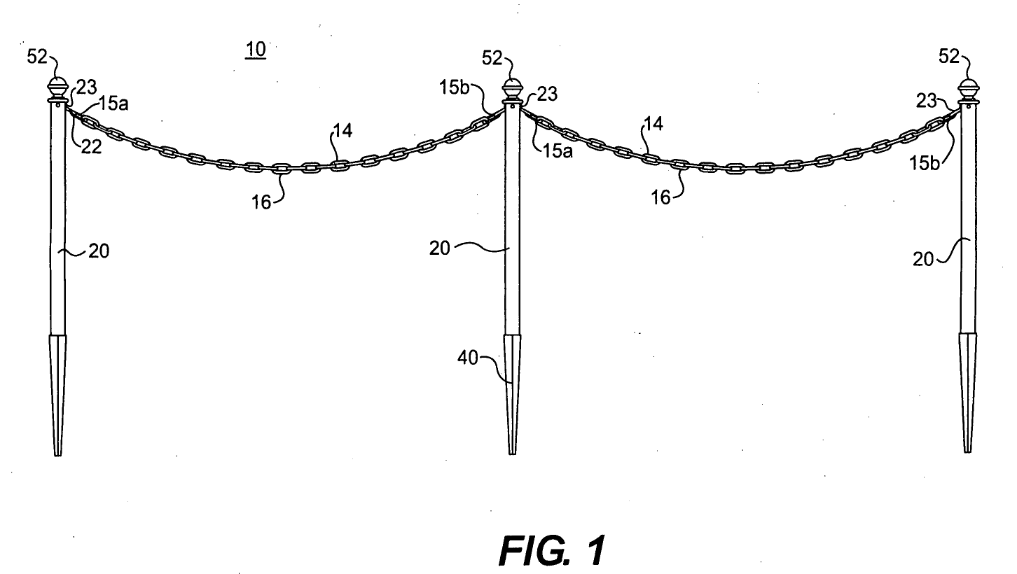

Referring to the drawings and, in particular, to FIGS. 1-7, the fencing system of the present invention, referred to generally by reference numeral 10, is illustrated.

The fencing system 10 includes a plurality of posts 20, which are removably, interchangeably staked into the ground, as explained in greater detail below. Each post has a uniform diameter d1. As embodied in FIG. 1, each post 20 includes a projecting open d-ring 23 proximate an upper end of the post.

In one embodiment, as broadly depicted in FIG. 1, one distal end 16 of chain 16 is suspended from open d-ring 23 on one post 20 and an opposite distal end of the chain 16 is suspended from an open d-ring 23 on the next successive post 20. The tautness or slackness of chain 16 is determined by the distance the two adjacent posts 20 are fixed apart in the ground.

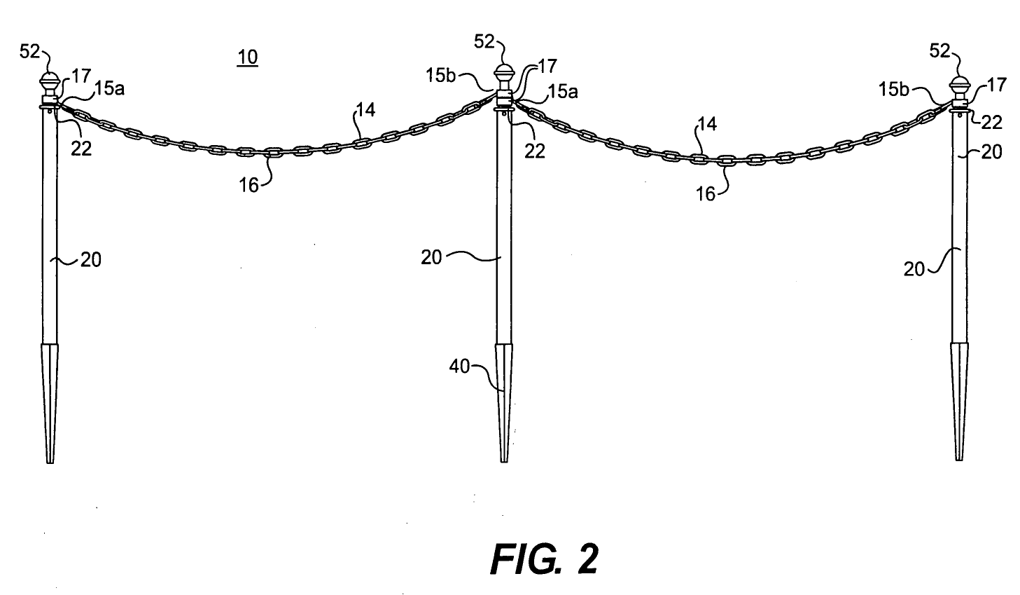

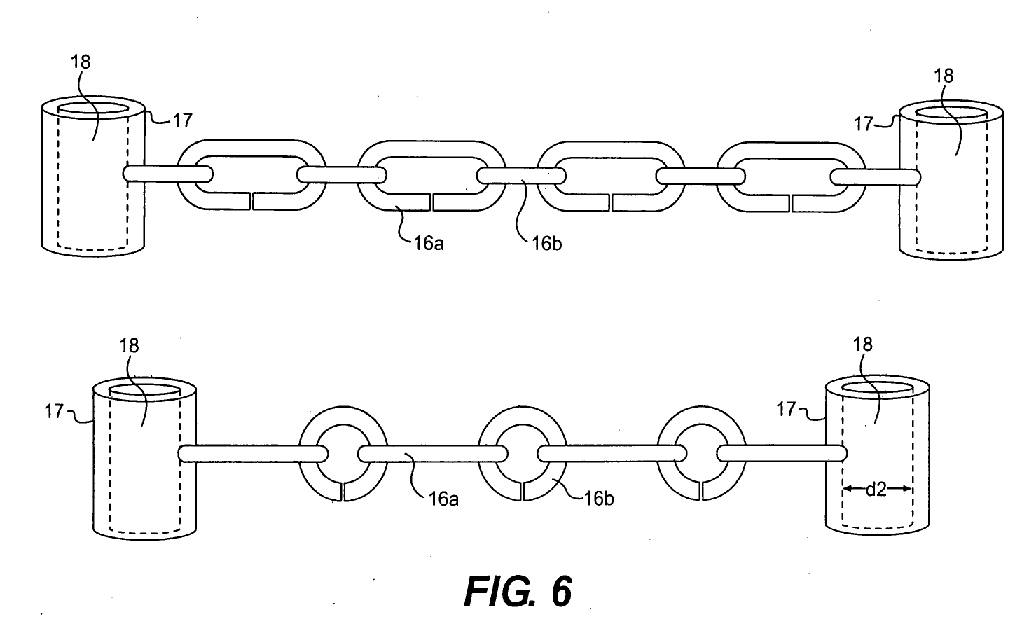

In another embodiment, as broadly depicted in FIGS. 2 and 6, a post attachment collar 17 is provided on each respective distal end of chain 16. Each post attachment collar 17 is generally cylindrical, and has a bore 18 extending therethrough. The bore 18 has a diameter d2, which is slightly larger than the diameter d1 of each post 20, so that each post attachment collar 17 can slide onto any selected post 20, to slidably, pivotally attach thereto. As depicted in FIG. 2, when a post attachment collar is attached to each post 20, it is supported and held in place by a detachable clamp 22, attached to the post 20 below the post attachment collar 17. As can be seen in FIG. 2, when two chains 16 are attached to one post 20, the bores 18 in two post attachment collars 17 are aligned, and the post 20 is inserted therethrough. The detachable clamp 22 is then attached beneath the lowermost post attachment collar 17 to hold the aligned post attachment collars 17, in place on the respective post.

The posts 20 of the fencing system 10 are secured to the ground by means of one or more stakes 40. The stakes 40 are designed to be driven into the ground and receive the posts 20 to thereby support the posts 20. In a preferred embodiment, the stakes 40 are wedge shaped or include a plurality of fins so as to facilitate their insertion into the ground, although a variety of alternative designs are possible. For example, the shape of the stakes 40 is designed with the idea that the stakes will be held in place in the ground. If the user prefers to dig a hole for the stakes 40, the stakes 40 could be provided in any shape or size. The only requirement is that the stakes are configured to receive and retain the posts 20.

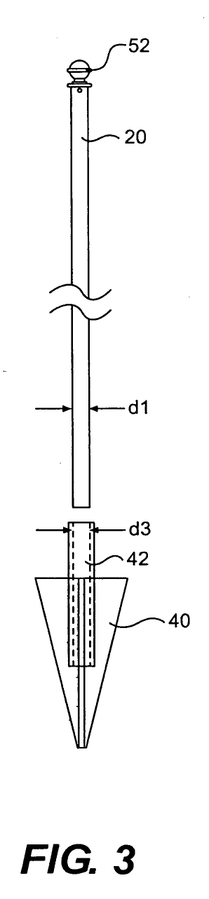

In one preferred embodiment, as broadly embodied in FIG. 3, the stakes 40 receive and retain lower distal ends 20a of the posts 20 by removably, interchangeably receiving the lower distal end 20a of one post 20 in a stake sleeve 42, essentially a cylindrical recess or cavity provided within the body of the stake 40 and having an internal diameter d3 slightly larger than the diameter d1 of the post 20, such that the post 20 will be received within and be interchangeably, removably, frictionally retained by the stake sleeve 42.

Ideally, the stake sleeve 42 should be of sufficient length so as to securely receive the post 20, and the length of the portion of the stake 40 that is inserted into the ground should be sufficient to prevent the post 20 from toppling over when the decorative fencing system 10 is assembled. In the above-described embodiment, the length of the portion of the stake 40 that is inserted into the ground preferably is approximately 10 inches, although longer stakes 40 also would function, and shorter ones may serve effectively provided the weight of the structural components and posts 20 is not too great, and the ground is firm enough to retain the stake 40 therein. Furthermore, the weight of the post 20 serves to force the post 20 into the stake sleeve 42 and prevent the post from sliding out.

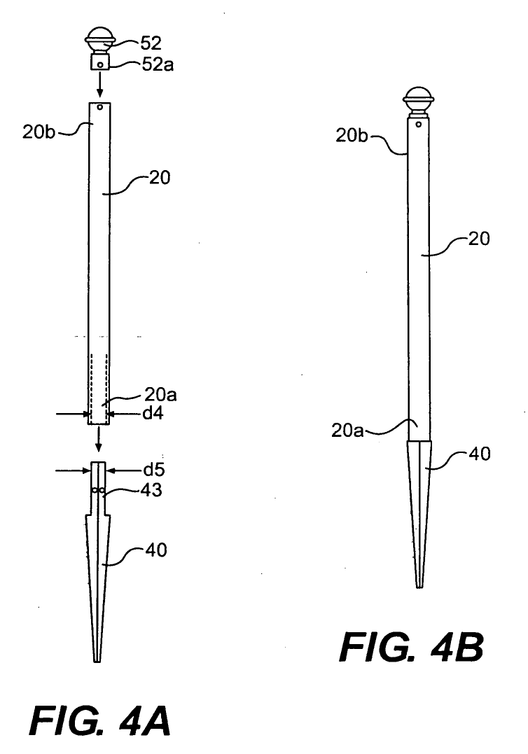

In another preferred embodiment, as broadly embodied in FIGS. 4A and 4B, the lower distal end 20a of end post 20 is hollow and has an internal diameter d4 slightly larger than a diameter d5 of a projecting portion 43 on stake 40, so that projecting portion 43 of stake 40 will be received within and be frictionally, interchangeably, removably retained by the lower distal end 20a of post 20.

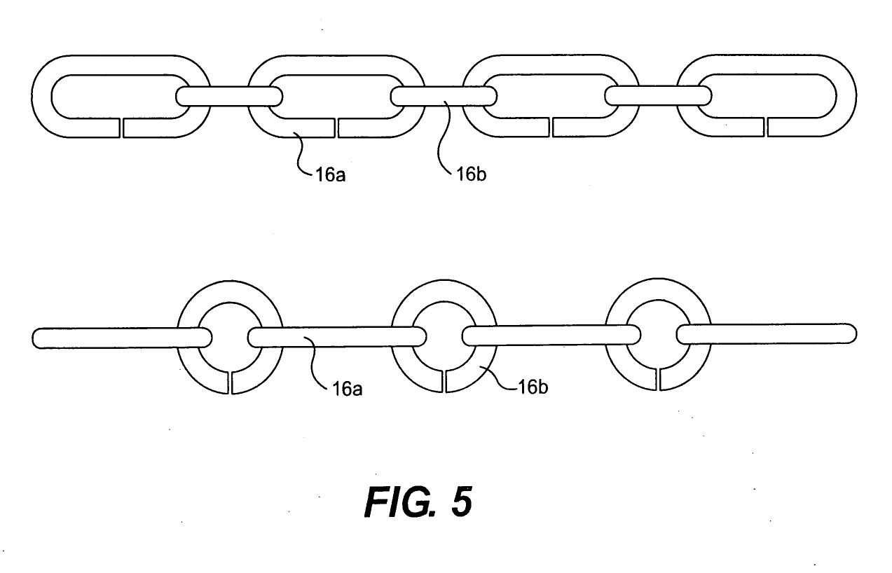

FIGS. 5 and 6 depict a pattern of large oval links 16a connected by a series of smaller circular links 16b. Chain 16, however, is not limited to this configuration, but have any embodiment of links, as desired by the user, and as well known in the art.

FIGS. 4A-4B depict installation of a decorative ball cap 52 on an upper distal end 20b of post 20. Ball cap 52 has a projecting portion 52a which inserts into an aperture in upper distal end 20b of post 20.

In the preferred embodiment, the components of the fencing system 10 are manufactured from tubular steel, both square and round stock. A powder coat finish may be provided on some or all of the elements. For example, a separate color or finish or a different material, such as bronze colored cast iron, may be used for decorative accents such as decorative a ball caps 52. All the steel components ideally are welded in assembly, and the decorative accents may be held in place by force fit, adhesive, welding, some combination thereof or by other means known in the art.

Alternative manufacturing variations also are contemplated, including manufacturing individual components out of solid iron or steel pieces, welding and finishing by powder coating or painting. The components may be produced as individual cast iron pieces and finished with various paint techniques to create different appearances.

It should be appreciated that the design of the individual structural components shown in the Figures is just one possible design for the fencing system 10 of the present invention. A variety of different designs and decorative accents 48 are contemplated. The only limitation is that the design of the system 10 must be embodied and tied together by the posts 20 and chains 16.

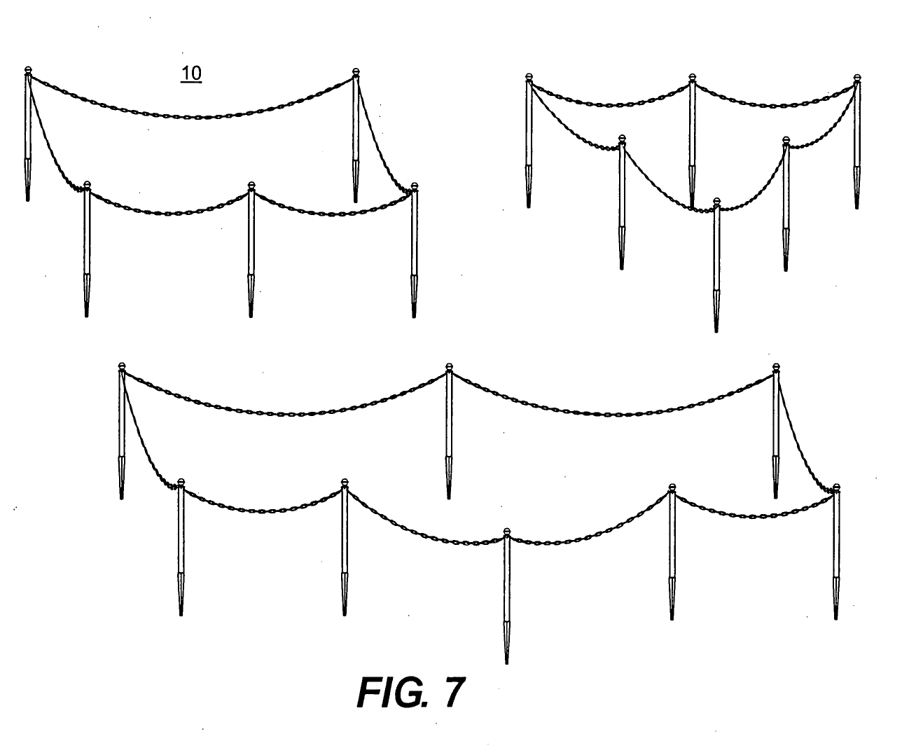

Referring to FIG. 7, the posts 20 can be set in the ground to define a variety of angles with respect to one another, in order to provide a wide variety of configurations.

Due to the above-discussed configuration of fencing system components, the process of assembling the fencing system 10 is simple and easy to alter, in order to obtain a variety of customizable patterns. In the first preferred embodiment, stakes 40 are driven into the ground, and selected posts 20 are removably interchangeably inserted into stake sleeves 42 of selected sakes 40. In another preferred embodiment, selected projecting sections 43 of selected stakes 40 are inserted into sleeves in the lower distal end 20a of selected posts 20. The assembly step forms one selected fence configuration. Next, in one embodiment, the distal ends section 15a and 15b of selected chains 16 are suspended on open d-rings 23 of selected posts 20. Subsequently, the chains 16 may be removed from the open d-rings 23, and the posts may be removed from the stakes. The posts may then be re-inserted into or onto different selected stakes 40, or else one or more of the stakes 40 may be withdrawn from the ground, moved into different positions and reinserted into the ground posts. The chains 16 are re-suspended from selected posts, defining a different selected fence configuration.

In another embodiment, bores 18 of post collars 17 of adjacent chains 16 are aligned, and a post 20 is inserted therethrough, into a stake 40. A detachable clamp ring 22 is attached below the lowermost post collar 17, to hold the post collars 17, and their respective chains 16, in position on the post 20. The same step is repeated on the adjacent post. In the case of an end post, with only a single distal end of a single chain 16 attachment, the post collar 17 is aligned with a selected stake 40, and a selected post 20 is inserted therethrough into the stakes. These steps, including removal of chains 16 from posts 20, removal of posts 20 from stakes 40, followed by reattachment of posts 20 to stakes 40, and reattachment of chains 16 to posts 20, are repeated until the desired fence configuration is achieved, either without moving any stakes 40, or removing and replacing selected stakes 40 in different locations, allowing for a potentially infinite number of combinations and angles between the structural components. Moreover, since each of the components may be purchased separately, the fencing system 10 may be as large or as small as the user desires.

Having thus described the invention with particular reference to the preferred forms thereof, it will be apparent that various changes and modifications can be made therein without departing from the spirit and scope of the present invention as defined by the appended claims.

What is claimed is:

1. A fencing system comprising:
a plurality of stakes, each stake adapted to be driven into the ground, said stake including a post-holding structure;
a plurality of posts, each post having a first diameter, and being adapted to be slidably, removably, and interchangeably held by one said post-holding structure in a selected one of said stakes; and
a plurality of chains, each chain adapted to be removably and interchangeably suspended between two selected adjacent posts.

2. The fencing system of claim 1, wherein said post holding structure comprises a stake sleeve defined in said stake, and having a second diameter larger than the first diameter, for receiving said post in frictional, removable, interchangeable engagement.

3. The fencing system of claim 1, wherein said post holding structure comprises an extending portion extending from said stake, configured to be received in a lower distal end sleeve in a lower distal end of said post, and being in removable frictional, interchangeable engagement with said lower distal end sleeve in said post.

4. The fencing system of claim 1, wherein said chains are suspended from said posts by hooking a distal link of each respective chain to an open ring attached to each said post.

5. The fencing system of claim 1, wherein each chain comprises at each distal end thereof a post attachment collar having a bore penetrating therethrough, each bore having a third diameter larger than the first diameter.

6. The fencing system of claim 5, further comprising a detachable clamp ring, attachable to each post below a lowermost post attachment collar.

7. A fencing system comprising:
A plurality of stakes adapted to be driven into the ground, each said stake comprising a post-holding structure;
a plurality of posts, each said post adapted to be removably, interchangeably and slidably retained by a selected one of said post-holding structures by means of frictional contact therebetween; and
at least one chain removably suspended between two selected posts.

8. The fencing system of claim 7, further comprising a post attachment collar provided at each distal end of each chain.

9. The fencing system of claim 7, further comprising an open ring attached to each post, from which distal end links of the chain are suspended to suspend chains from adjacent posts.

10. A fencing system comprising:
a plurality of stakes, each stake adapted to be driven into the ground, said stake including a post-holding structure;
a plurality of posts, each post having a first diameter, each post being adapted to be slidably, removably, and interchangeably held by one of said post holding structures in a selected one of said plurality of stakes; and
a plurality of chains, each chain having a post attachment collar at each distal end thereof, each post attachment collar having a bore provided therethrough, having a second diameter larger than the first diameter, said post attachment collars slidably, rotatably, removably, and interchangeably attaching to said posts to thereby connect adjacent chains to each other via one of said posts while allowing adjacent chains to be rotationally adjusted relative to said post; and
wherein said post attachment collars of a pair of selected adjacent chains are configured to be aligned, and a selective post inserted therethrough and onto a post holding structure of a selected stake.

11. The fencing system of claim 10, wherein the post holding structure on each stake comprises a stake sleeve provided in the stake, having a third diameter larger than the first diameter of each post, so that any post can slidably, removably, and interchangeably insert into any stake sleeve, and be frictionally held thereby.

12. The fencing system of claim 10, further comprising a plurality of clamp rings, any one clamp ring attachable to any post below a lowermost post attachment collar to hold the post attachment collars in place.

13. The fencing system of claim 10, wherein the post holding structure on each stake includes a projecting rod portion having a fourth diameter smaller than a fifth diameter of a post sleeve provided at a lower distal end of each post so that each stake projecting rod can slidably, removably, and interchangeably insert into any post sleeve and be removably, frictionally held thereby.

14. A fencing system comprising:
a plurality of stakes, each stake adapted to, be driven into the ground, said stake including a post-holding structure;
a plurality of posts, each post having a first diameter, each post being adapted to be slidably, removably, and interchangeably held by one of said post holding structures in a selected one of said plurality of stakes; and
a plurality of chains, each chain having a post attachment collar at each distal end thereof, each post attachment collar having a bore provided therethrough, having a second diameter larger than the first diameter, said post attachment collars slidably, rotatably, removably, and interchangeably attaching to said posts to thereby connect adjacent chains to each other via one of said posts while allowing adjacent chains to be rotationally adjusted relative to said post; and
wherein a post attachment collar of a selected chain is configured to be aligned with a post holding structure of a selected stake, and a selected post inserted therethrough and onto the post holding structure of the selected stake.

15. A method for assembling a fencing system, said method comprising the steps of:
providing a plurality of stakes adapted to be driven into the ground, each said stake including a post-holding structure;
providing at least two posts, said posts being adapted to be removably, interchangeably and slidably inserted onto and retained by the post-holding structures; and
providing a plurality of chains, each chain removably suspendable between two selected adjacent posts, each chain having a post attachment collar at each distal end, each post attachment collar having a bore provided therethrough;
driving said stakes into the ground;
positioning said selected adjacent posts over selected stakes;
inserting said posts on the post-holding structures through aligned bores in aligned post attachment collars of distal ends of two adjacent chains, onto a respective post-holding structure of two selected stakes so as to be removably interchangeably, and frictionally engaged thereby; and
attaching clamp rings to said posts below the lowermost post attachment collar on each post to removably suspend each chain between the two respective selected adjacent posts.

16. The method of claim 15, further comprising the steps of
removing the chain from the two selected adjacent posts;
removing said posts from said post-holding structures in said selected stakes;
inserting said two selected posts on post-holding structures onto post-holding structures on different stakes;
removably suspending said chain between said two selected posts.

17. The method of claim 15, wherein said post-holding structure comprises a stake sleeve for slidably, removably and interchangeably receiving posts therein.

18. The method of claim 15, wherein said post-holding structure comprises a projecting portion projecting from each said stake, for slidably, removably, and interchangeably inserting into a sleeve in a lower distal end of each post.

19. The method of claim 15, further comprising a step of suspending a plurality of chains between selected posts.

20. A method for assembling a fending system, said method comprising the steps of:
providing a fencing system comprising:
a plurality of stakes configured to be driven into the ground, each said stake including a post attachment structure;
a plurality of posts, each said post having a first diameter, any one of said posts slidably, interchangeably, frictionally and removably attaching to any one of said stakes; and
a plurality of chains, each said chain including a pair of post attachment collars, one of said post attachment collars disposed at each distal end of each said chain, said post attachment collars each having a bore therethrough with a second diameter larger than said first diameter of said post, any one of said post attachment collars slidably, removably and interchangeably attaching to any one of said posts to thereby attach the chain to adjacent posts;
driving said stakes at a plurality of selected locations into the ground;
positioning a post attachment collar of a selected chain over a respective selected one of said stakes such that the opening the post attachment collar is axially aligned with the respective selected one of said stakes; and
inserting one of said posts downwardly through the post attachment collar into said post attachment structure in said respective selected one of said stakes so as to be removably, interchangeably, frictionally engaged thereby.

21. The method of claim 20, further comprising the step of customizing and adjusting said fencing system by:
removing one or more of said posts from corresponding respective stakes;
removing one or more of said chains from one or more said posts, one or more of said corresponding stakes;
repositioning said one or more chains with a pair of post attachment collars aligned over said corresponding one or more said stakes; and
reinserting said one or more posts through respective said aligned post attachment collars of said one or more said chains and into said corresponding one or more stakes.

22. The method of claim 20, wherein said step of customizing and adjusting said fencing system further comprises the steps of:
after removing said one or more of said posts from said one or more said structural fencing components and said corresponding one or more stakes, and prior to repositioning said one or more structural fencing components over said corresponding one or more said stakes, removing one or more of said stakes from the ground;
moving said one or more of said stakes to a different location; and
reinserting said one or more of said stakes into the ground at said different location.

23. A method for assembling a fencing system, said method comprising the steps of:
providing a fencing system comprising:
a plurality of stakes configured to be driven into the ground, each said stake including a post attachment structure;
a plurality of posts, each said post having a first diameter, any one of said posts slidably, interchangeably frictionally and removably attaching to any one of said stakes; and
a plurality of chains, each said chain including a pair of post attachment collars, one post attachment collar at each distal end of said chain, said post attachment collars each having a bore therethrough with a second diameter larger than said first diameter of said post, said chain slidably, removably, and interchangeably attaching to said posts to thereby connect adjacent chains to each other via one of said posts while allowing said adjacent chain to be rotationally adjusted relative to said one post;
driving a first said stake at a selected location into the ground;
positioning a first post attachment collar of a first said chain over said first stake such that said openings of said post attachment collar of said first chain is axially aligned with said first stake;
inserting a first said post downwardly through said aligned first post attachment collar of said first chain into said post attachment structure first stake so as to be removably, frictionally engaged thereby;
driving a second said stake at a selected location into the ground;
positioning a second said post attachment collar of a second chain over said second stake such that said openings of said second post attachment collar of said second chain is axially aligned with said second stake; and
inserting a second said post downwardly through said aligned second pair of post attachment collars of said second chain into said post attachment structure of said second stake so as to be removably, frictionally engaged thereby.

24. The method of claim 23, further comprising the step of customizing and adjusting said fencing system by:
removing one or more of said posts from one or more said chains and one or more corresponding post attachment structures in one or more said stakes;
repositioning said one or more structural fencing components over said corresponding one or more said stakes; and
reinserting said one or more posts through respective said post attachment collars of said one or more said chains and into said corresponding one or more post attachment structures in one or more stakes.

25. The method of claim 23, wherein said step of customizing and adjusting said fencing system further comprises the steps of:
after removing said one or more of said posts from said one or more said chains and said corresponding one or more stakes, and prior to repositioning said one or more chains over said corresponding one or more said stakes, removing said one or more of said stakes from the ground;
moving said one or more of said stakes to a different location; and
reinserting said one or more of said stakes into the ground at said different location.
